(19) United States
(12) Patent Application Publication
(10) Pub. No.: US 2005/0135486 A1
(43) Pub. Date: Jun. 23, 2005

(54) Transcoding method, medium, and apparatus

(75) Inventor: Yung-lyul Lee, Seoul (KR)

Correspondence Address: STAAS & HALSEY LLP, SUITE 700, 1201 NEW YORK AVENUE, N.W., WASHINGTON, DC, 20005, US

(73) Assignees: DAEYANG FOUNDATION (SEJONG UNIVERSITY), Seoul (KR); SAMSUNG ELECTRONICS CO., LTD., Suwon-si (KR)

(21) Appl. No.: 10/945,874

(22) Filed: Sep. 22, 2004

(30) Foreign Application Priority Data
Dec. 18, 2003 (KR) 2003-93159

(51) Int. Cl. H04N 7/12

(52) U.S. Cl. 375/240.16; 375/240.12; 375/240.24

(57) ABSTRACT

A transcoding method, medium, and apparatus for transforming a coded video format into another coded video format. The transcoding method includes decoding a bitstream encoded using a first coding method to output data in a pixel domain and motion vector and macroblock information for each of macroblock of the bitstream, and performing motion compensation using the motion vector and macroblock information to encode the data in the pixel domain using a second coding method.

### CROSS-REFERENCE TO RELATED APPLICATIONS

This application claims the priority benefit of Korean Patent Application No. 2003-93159, filed on Dec. 18, 2003, in the Korean Intellectual Property Office, the disclosure of which is incorporated herein in its entirety by reference.

### BACKGROUND OF THE INVENTION

1. Field of the Invention

The present invention relates to transcoding, and more particularly, to a transcoding method, medium, and apparatus for transforming a coded video format into another coded video format.

2. Description of the Related Art

The advances in computer and communications technologies enable the transmission of various types of data via a network. A variety of multimedia data compression formats have been introduced to transmit a mass of multimedia data via a network. Also, since the encoding and/or decoding systems for a transmitter and a receiver may differ, a data format may need to be transformed into another data format, in consideration of Quality of Service (QoS) for the transmitter and the receiver. This transforming between data formats is called “transcoding.” Video transcoding is classified into a transcoding method in a pixel domain and a transcoding method in a frequency domain, for example, a Discrete Cosine Transform (DCT) domain.

For transcoding in a pixel domain, decoding and encoding must be re-performed. Thus, motion prediction must be re-executed for all macroblocks in all frames. Accordingly, since the pixel-domain transcoding is time-consuming, it is difficult to transmit transcoded video in real time.

### SUMMARY OF THE INVENTION

The present invention provides a transcoding method and apparatus for efficiently transforming types of and motion vectors in blocks used for motion prediction to be suitable for a compression format to be transcoded.

Additional aspects and/or advantages of the invention will be set forth in part in the description which follows and, in part, will be obvious from the description, or may be learned by practice of the invention.

To achieve the above and/or additional aspects and advantages, embodiments of the present invention include a transcoding method, including decoding a bitstream, encoded using a first coding method, to output data in a pixel domain along with motion vector and macroblock information, for each macroblock of the bitstream, and performing motion compensation using the motion vector and macroblock information to encode the data in the pixel domain using a second coding method.

The performing of the motion compensation may include receiving a block mode and the motion vector and macroblock information for a macroblock of the bitstream, transforming the block mode of the macroblock into one of 16×16 and 8×8 block modes, and mapping motion vectors in the macroblock to motion vectors in one of 16×16 and 8×8 blocks.

Further, the first coding method may comply with an H.264 standard and the second coding method may comply with an MPEG-4 standard.

To achieve the above and/or additional aspects and advantages, embodiments of the present invention include a transcoding method, including receiving block mode and motion vector information for a macroblock of video encoded using a predetermined coding method, transforming a block mode of the macroblock into one of 16×16 and 8×8 block modes, and mapping a motion vector in the macroblock to a motion vector in one of 16×16 and 8×8 blocks.

The transcoding method may further include performing motion estimation on pixels neighboring a pixel with coordinates of the mapped motion vector to obtain motion vector coordinates, making half pixels around pixels with the obtained motion vector coordinates, and performing motion estimation on the half pixels to determine the mapped motion vector in the macroblock.

The transcoding method may include transforming the block mode of the macroblock into one of intra-16×16, inter-16×16, and inter-8×8 modes based on the block mode of the macroblock. Further, when the block mode of the macroblock is one of intra-16×16 and intra-4×4 modes, the block mode may be transformed into the intra-16×16 mode. Similarly, when the block mode of the macroblock is one of inter-16×16 and skip modes, the block mode may be transformed into the inter-16×16 mode. When the block mode of the macroblock includes three information blocks, the block mode may be transformed into the intra-16×16 mode. Alternatively, when the block mode of the macroblock includes one or two information blocks or is one of inter-16×8, inter-8×16, and inter-P8 modes, the block mode can be transformed into the inter-8×8 mode.

In addition, an average of motion vectors in blocks in the macroblock corresponding to the 8×8 block, in which the motion vector is to be determined, can be mapped as the motion vector for the 8×8 block. Further, when a block in the macroblock corresponding to the 8×8 block, in which the motion vector is to be determined, is an intra block, motion vectors in blocks adjacent to the intra block can be averaged to map the average as the motion vector for the 8×8 block. Similarly, the mapping of the motion vector in the macroblock to the motion vector in one of 16×16 and 8×8 blocks may include mapping with a ratio of 2:1 or 4:1.

To achieve the above and/or additional aspects and advantages, embodiments of the present invention include a transcoding apparatus, including a decoder to decode a bitstream, encoded using a first coding method, to output data in a pixel domain along with motion vector and macroblock information for each of macroblock of the bitstream, and an encoder to receive the data in the pixel domain and perform motion compensation using the motion vector and macroblock information to encode the data in the pixel domain using a second coding method.

The encoder may include a motion compensator to receive information on a block mode and motion vector in a macroblock of the bitstream, to transform the block mode into one of 16×16 and 8×8 modes, and to map the motion vector to a motion vector in the one of 16×16 and 8×8 blocks. The motion compensator may perform motion estimation on pixels neighboring a pixel with coordinates of the mapped motion vector to obtain motion vector coordinates, makes half pixels around pixels with the obtained motion vector coordinates, and performs motion estimation on the half pixels to determine the mapped motion vector in the macroblock.

To achieve the above and/or additional aspects and advantages, embodiments of the present invention include a transcoding apparatus, including a decoder to decode a bitstream, encoded using a first coding method, to output data in a pixel domain, and an encoder to receive the data in the pixel domain and to encode the data in the pixel domain using a second coding method with motion compensation based on motion compensation information obtained during the decoding of the bitstream encoded using the first coding method.

To achieve the above and/or additional aspects and advantages, embodiments of the present invention include an encoding apparatus, including an encoder to encode data in a pixel domain using a first coding method with motion compensation based on motion compensation information obtained during a previous decoding of encoded data, corresponding to the data encoded by the encoder, encoded with a second coding method.

Lastly, to achieve the above and/or additional aspects and advantages, embodiments of the present invention include a media including computer readable code controlling a computing device to perform a method of the presently claimed invention. Similarly, embodiments of the present invention may include computer readable code controlling a transcoding and/or encoding apparatus embodiment of the present invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1A illustrates blocks used in motion estimation (ME) according to the H.264 standard;

FIG. 1B illustrates blocks used in ME according to the Moving Picture Experts Group (MPEG)-4 standard;

FIG. 2 illustrates a pixel-domain transcoding apparatus, according to an embodiment of the present invention;

FIGS. 3A-3F are illustrations explaining a process of transforming a coding mode and a motion vector in a macroblock of an H.264 bitstream into a coding mode and a motion vector in a macroblock of an MPEG-4 bitstream, according to an embodiment of the present invention;

FIG. 4 is a flowchart illustrating a transcoding method, according to an embodiment of the present invention;

FIG. 5A is a graph of a peak signal-to-noise ratio (PSNR) of a brightness signal when a Foreman video is coded into H.264 video and into MPEG-4 video using cascaded transcoding and the transcoding method according to an embodiment of the present invention; and

FIG. 5B is a graph of a PSNR of a brightness signal when a Mother & Daughter (M & D) video is coded into H.264 video and into MPEG-4 video using cascaded transcoding and the transcoding method according to an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

A pixel-domain transcoding apparatus, according to an embodiment of the present invention, transforms video coded by an H.264 Baseline profile (BP) into an MPEG-4 Simple profile (SP) format. H.264 is the ITU-T Recommendation H.264, which is a moving picture compression standard that provides high-quality video at a lower bit rate, and is also known as ISO/IEC MPEG-4 Part 10 Advanced Video Coding.

H.264 is designed to be unassociated with H.261, H.263, MPEG-2, and MPEG-4. Thus, H.264 includes different features than MPEG-4. For example, H.264 performs Integer DCT on each 4×4 block, of a macroblock, while MPEG-4 performs DCT on each 8×8 block, of a macroblock. Also, for motion compensation (MC), H.264 carries out motion prediction on a quarter pixel basis to improve the accuracy of MC, whereas MPEG-4 carries out motion estimation (ME) on a half pixel basis. Furthermore, for intra prediction, H.264 executes spatial prediction, but MPEG-4 executes alternating current (AC) and/or direct current (DC) prediction. H.264 uses different types of blocks from MPEG-4 in ME. Likewise, for Variable Length Coding (VLC), H.264 uses universal variable length codes, while MPEG-4 uses the Huffman table.

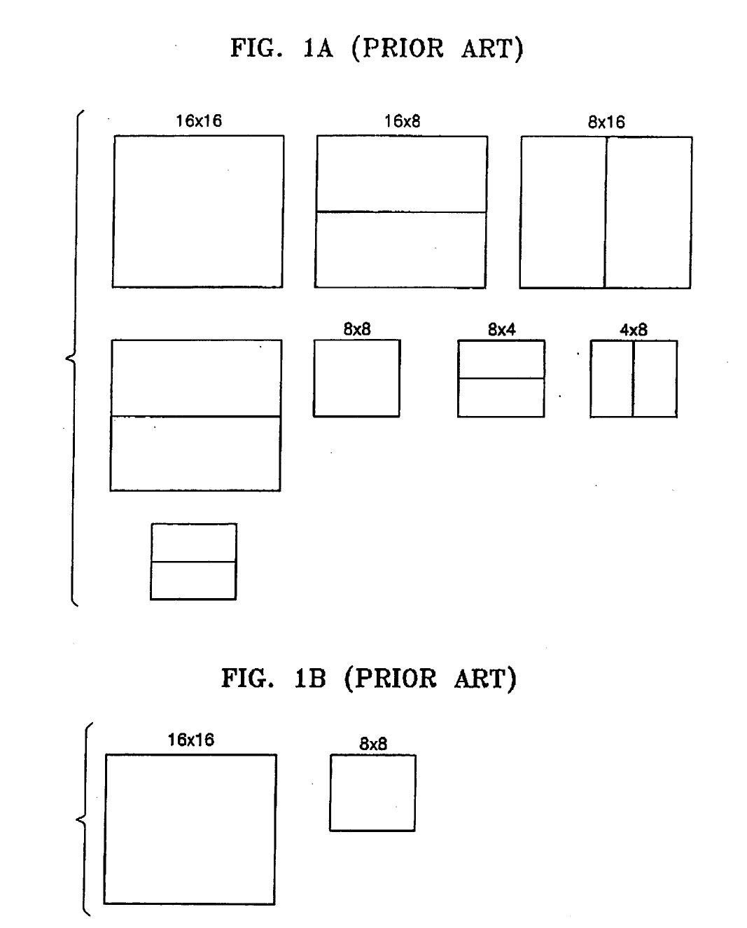

FIG. 1A illustrates blocks used in ME according to the H.264 standard. Referring to FIG. 1A, an H.264 macroblock of 16×16 pixels may be divided into 7 variable blocks, each of which may have a motion vector. In other words, the H.264 macroblock of 16×16 pixels may be divided into 8×16, 16×8, or 8×8 blocks, and one of the 8×8 blocks may be subdivided into 4×8, 8×4, or 4×4 blocks.

FIG. 1B illustrates blocks used in ME according to the MPEG-4 standard. Referring to FIG. 1B, MPEG-4 uses two types of macroblocks: macroblocks of 16×16 pixels and 8×8 pixels. Thus, block type transformation is required to transform an H.264 video format into an MPEG-4 video format. Hereinafter, it will be explained how to transform block type and motion information for an H.264 block, to transform an H.264 moving picture format into an MPEG-4 moving picture format so as to reduce the time required for transcoding.

An example of transcoding in a pixel domain includes Cascaded Pixel-domain Transcoding. In the Cascaded Pixel-domain Transcoding, input H.264 frames are decoded and then coded according to the MPEG-4 standard. Thus, in this technique, motion prediction must be re-performed on all macroblocks in all the H.264 frames during MPEG-4 coding, which is time-consuming and costly. Thus, the Cascaded Pixel-domain Transcoding is not suitable for real-time transmission.

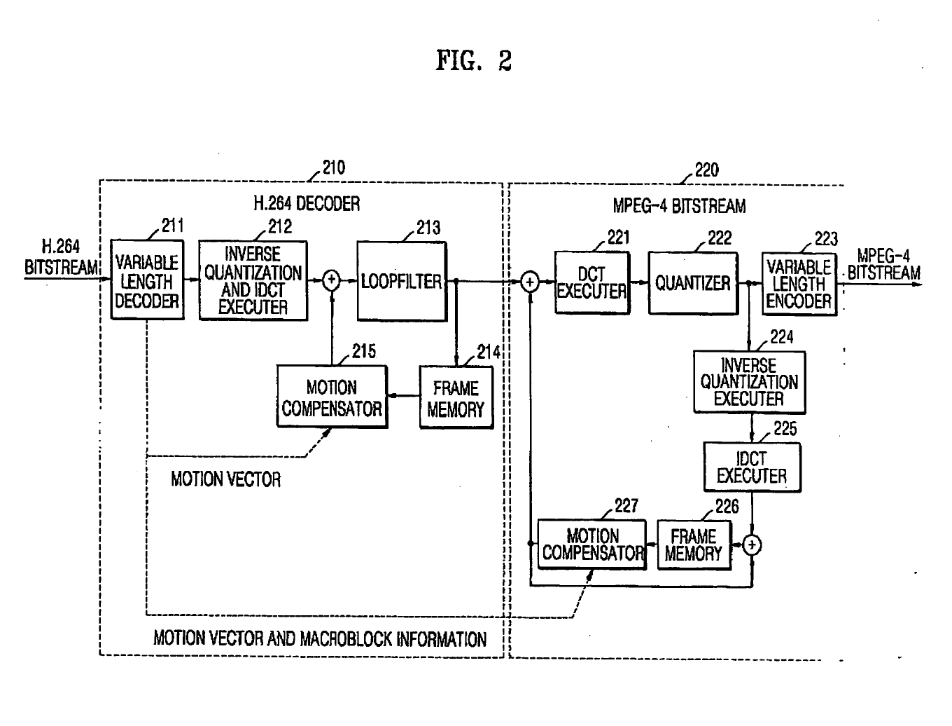

FIG. 2 illustrates a pixel-domain transcoding apparatus, according to an embodiment of the present invention.

The pixel-domain transcoding apparatus allows an MPEG-4 encoder 220 to use block mode and motion vector information used in an H.264 decoder 210 to enable a real-time transmission with a reduction in transcoding time. The pixel-domain transcoding apparatus includes the H.264 decoder 210 and the MPEG-4 encoder 220, to respectively decode an H.264 bitstream into pixel domains and then transform the pixel domains into an MPEG-4 bitstream.

A variable length decoder 211 receives the H.264 bitstream, performs Variable Length Decoding (VLD) on the H.264 bitstream, and outputs information on the decoded H.264 bitstream, including formats of frames of the decoded H.264 bitstream, macroblocks, and motion vectors of the decoded H.264 bitstream. The frame format information represents the formats of I and P frames, and the macroblock information indicates what type of variable blocks are used to perform ME on the macroblocks. The motion vector information is transmitted to a motion compensator 215 in the H.264 decoder 210 and a motion compensator 227 in the MPEG-4 encoder 220. The macroblock information is transmitted to the motion compensator 227 in the MPEG-4 encoder 220.

An inverse quantization and inverse DCT executer 212 performs Inverse Quantization and Inverse DCT (IDCT) on the H.264 bitstream that has undergone VLD. A loop-filter 213 is a type of a low-pass filter (LPF) and serves to smooth the border between blocks. Frames which have been transformed into pixel domains are stored in a frame memory 214 and then input to the motion compensator 215 to be used in MC as well as being output to the MPEG-4 encoder 220. The motion compensator 215 performs MC using the motion vector information received from the variable length decoder 211.

The MPEG-4 encoder 220 passes the frames through a DCT executer 221, a quantizer 222, and a variable length encoder 223 to transform the frames into an MPEG-4 bitstream using a general MPEG-4 encoding method. Since the MPEG-4 encoder 220 requires MC, the motion compensator 227 of the MPEG-4 encoder 220 performs MC using the motion vector and macroblock information received from the H.264 decoder 210. The motion compensator 227 performs MC using frames stored in a frame memory 226. The MPEG-4 bitstream is first decoded via an inverse quantizer 224 and an inverse DCT executer 225 and then stored in the frame memory 226.

In a case where the variable length decoder 211 decodes the H.264 bitstream into Predictive (P) frames, the MPEG-4 encoder 220 reuses the H.264 block types and motion vectors of macroblocks to omit time-consuming motion prediction. However, since the H.264 standard provides motion prediction and MC for quarter pixels, 7 variable block coding modes, and 11 macroblock coding modes, the block types of the macroblocks of the H.264 bitstream must first be transformed into types that the MPEG-4 encoder 220 can use, so that such motion prediction, MC, and modes can be reused.

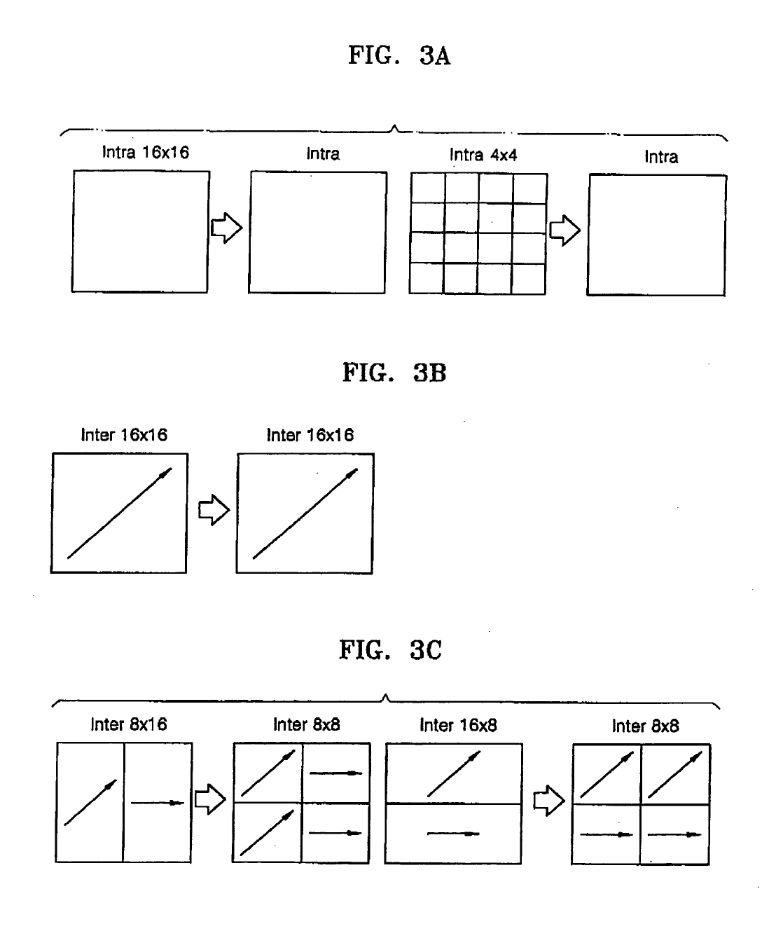

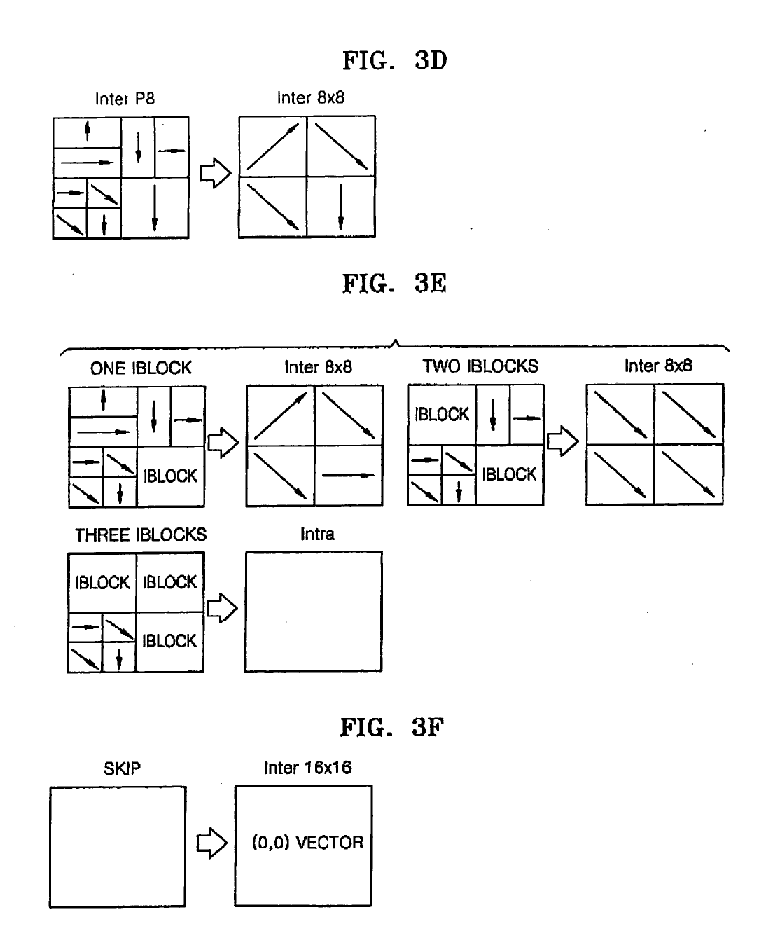

FIGS. 3A through 3F illustrate a process of transforming a coding mode and a motion vector of a macroblock of an H.264 bitstream into a coding mode and a motion vector of a macroblock of an MPEG-4 bitstream, according to an embodiment of the present invention. Referring to FIG. 3A, when an H.264 macroblock is coded in an intra-16×16 or 4×4 mode, the mode of an MPEG-4 macroblock is transformed into an intra-mode.

Referring to FIG. 3B, when an H.264 macroblock is coded in an inter-16×16 mode, and a motion vector therein is as shown in FIG. 3B, the MPEG-4 macroblock uses an inter-16×16 mode and the same motion vector as the H.264 macroblock. Here, since the MPEG-4 macroblock is also coded in the inter-16×16 mode, 1:1 mapping may be performed in the MPEG-4 macroblock.

When an H.264 macroblock is coded in an inter-16×8 or 8×16 mode, and motion vectors therein are as shown in FIG. 3C, the mode of an MPEG-4 macroblock is transformed into an inter-8×8 mode. Also, after the 16×8 or 8×16 blocks are segmented into 8×8 blocks, motion vectors in the 16×8 or 8×16 blocks are mapped in the 8×8 blocks.

Referring to FIG. 3D, when an H.264 macroblock is coded in inter-8×4, 4×8, and 4×4 modes, the mode of the MPEG-4 macroblock is transformed into an inter-8×8 mode. A motion vector in each block of the H.264 macroblock is mapped, with the ratio of 2:1 or 4:1, into the MPEG-4 macroblock. In other words, motion vectors in the two 8×4 blocks at the left top of the H.264 macroblock are averaged to be transformed into a motion vector in an 8×8 block at the left top of the MPEG-4 macroblock. Motion vectors in the two 4×8 blocks at the right top of the H.264 macroblock are averaged to be transformed into a motion vector in an 8×8 block at the right top of the MPEG-4 macroblock. Motion vectors in the four 4×4 blocks at the left bottom of the H.264 macroblock are averaged to be transformed into a motion vector in an 8×8 block at the left bottom of the MPEG-4 macroblock. A motion vector in the 8×8 block at the right bottom of the H.264 macroblock is equal to a motion vector in an 8×8 block at the right bottom of the MPEG-4 macroblock.

The H.264 macroblock may further include an intra-8×8 block. As shown in FIG. 3E, when the H.264 macroblock includes intra blocks (IBLOCKs), i.e., intra-8×8 blocks, modes and motion vectors in the MPEG-4 macroblock vary with the number of the IBLOCKs.

When the H.264 macroblock includes one or two IBLOCKs, the mode of the MPEG-4 macroblock is transformed into an inter-8×8 mode. Motion vectors in blocks adjacent to the IBLOCKs are averaged to be transformed into motion vectors in 8×8 blocks of the MPEG-4 macroblock. However, when the H.264 macroblock includes three IBLOCKs, the H.264 macroblock is transformed into an intra block.

As shown in FIG. 3F, when the H.264 macroblock is coded in a skip mode, the skip mode is transformed into an inter-16×16 mode, and then a motion vector is set to (0, 0).

As described above, the type of a block is transformed into another type from which a motion vector is obtained, and motion vectors are searched for 8 neighbor pixels around the obtained motion vector. Next, half pixels around the searched motion vectors are made using an interpolation method, with motion vectors being searched for the half pixels. As a result, a peak signal to noise ratio (PSNR) can be improved.

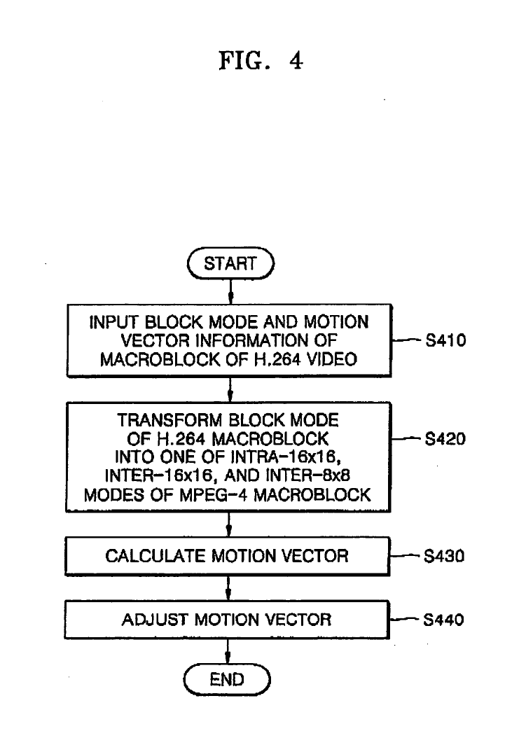

FIG. 4 is a flowchart illustrating a transcoding method, according to an embodiment of the present invention. Referring to FIG. 4, in operation S410, information of a mode and a motion vector in a macroblock of H.264 video is received. In operation S420, one of intra-16×16, inter-16×16, and inter-8×8 modes is determined as the mode of the H.264 macroblock. The determination of the mode satisfying the conditions of the H.264 macroblock is described with reference to FIGS. 3A through 3F. In operation S430, the motion vector in the H.264 macroblock is transformed into a motion vector in an MPEG-4 macroblock. In other words, the H.264 macroblock is mapped with a motion vector in a 16×16 or 8×8 block. In operation S440, ME is performed on pixels, neighboring pixels with coordinates of the calculated motion vector, to obtain motion vector coordinates, half pixels around pixels with the obtained motion vector coordinates are made, and ME is performed on the half pixels to determine the motion vector in the H.264 macroblock.

Accordingly, transformation speed is improved and video quality varies with the implementation of the transcoding apparatus and method embodiments of the present invention. In one experiment, a transcoding apparatus embodiment was embodied with a Joint Model (JM) decoder decoding an H.264 BP bitstream and a MoMuSys-FDIS-V1.0 encoder encoding the H.264 BP bitstream into an MPEG-4 SP bitstream. The experiment was carried out in a Pentium IV 2.4 GHz personal computer (PC), and the transcoding apparatus received a Foreman bitstream encoded by a JM encoder and an H.264 bitstream of 100 Kbps into which a Mother and Daughter (M&D) QCIF (176×144) video was compressed. The Foreman bitstream or the 100 Kbps-H.264 bitstream included 300 image frames of a 10 Hz frame rate, the first image frame of which was an intra frame and the rest of which were P frames.

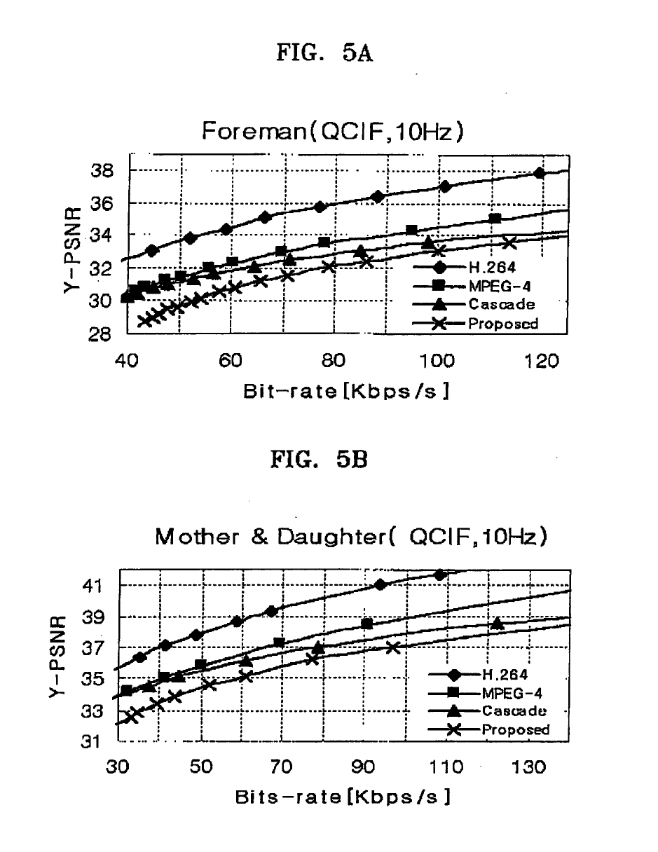

FIG. 5A is a graph of variations in a peak signal-to-noise ratio (PSNR) of a brightness signal when Foreman video is coded into H.264 video and into MPEG-4 video using cascaded pixel-domain transcoding and the transcoding method according to an embodiment of the present invention. Referring to FIG. 5A, a difference of about 1.3 dB in a PSNR occurs between H.264 video of 100 Kbps and MPEG-4 video of 50 Kbps, into which Foreman video is coded, using the cascaded pixel-domain transcoding method and this transcoding method embodiment of the present invention.

FIG. 5B is a graph for showing variations in a PSNR of a brightness signal when the M & D video is coded into H.264 video and into MPEG-4 video using cascaded pixel-domain transcoding and a transcoding method embodiment of the present invention. As can be seen in FIG. 5B, in a case of the M & D video, a difference of about 1 dB in a PSNR occurs. However, when the transmission speed is increased to 100 Kbps or more, the difference in the PSNR is reduced.

These results are summarized in Tables 1 and 2 below.

TABLE 1

| | | | | Time (sec.) | |
|---|---|---|---|---|---|
| | PSNR (dB) | | | H.264 | MPEG-4 |
| | Y | Cb | Cr | Decoder | Encoder |
| Cascaded Pixel- | 30.97 | 36.33 | 37.1 | 2.65 | 11.46 |
| domain Transcoding | | | | | |
| Present Embodiment | 29.71 | 35.44 | 36.32 | 2.65 | 2.42 |

TABLE 2

| | | | | Time (sec.) | |
|---|---|---|---|---|---|
| | PSNR (dB) | | | H.264 | MPEG-4 |
| | Y | Cb | Cr | Decoder | Encoder |
| Cascaded Pixel- | 35.5 | 39.95 | 39.68 | 2.62 | 11.37 |
| domain Transcoding | | | | | |
| Present Embodiment | 34.56 | 39.08 | 38.93 | 2.62 | 2.39 |

Each of Tables 1 and 2 show comparisons between average PSNRs and between the total transformation times when an H.264 bitstream of 100 Kbps, including 100 frames, is transformed into an MPEG-4 bitstream of 50 Kbps using the cascaded pixel-domain transcoding method and the transcoding method according to the present invention. In Table 1, input video is Foreman video, and in Table 2, input video is M & B video. As can be seen in Tables 1 and 2, when a transcoding method of the present invention is used, the transcoding speed is increased by about 2.7 times. In comparison with only the transcoding speeds in the MPEG-4 encoder, the transcoding speed is increased by about 4.7 times with a transcoding method of the present invention.

As described above, in a transcoding apparatus, medium, and method of the present invention, H.264 video can be played in real-time in a conventional MPEG-4 terminal. As a result, the wasting of resources is prevented.

As referenced above, embodiments of the present invention can be embodied as computer readable code in a medium, e.g., on a computer readable recording medium. Codes and code segments for implementing embodiments of the present invention can be easily construed by programmers skilled in the art to which the present invention pertains. The computer readable code can be stored in a medium, and read and executed by a computer so as to realize a transcoding method, for example. Examples of the medium include magnetic recording media, optical recording media, and carrier waves, the Internet, and waveguides, for example.

Although a few embodiments of the present invention have been shown and described, it would be appreciated by those skilled in the art that changes may be made in these embodiments without departing from the principles and spirit of the invention, the scope of which is defined in the claims and their equivalents.

1. A transcoding method, comprising:
decoding a bitstream, encoded using a first coding method, to output data in a pixel domain along with motion vector and macroblock information, for each macroblock of the bitstream; and
performing motion compensation using the motion vector and macroblock information to encode the data in the pixel domain using a second coding method.

2. The transcoding method of claim 1, wherein the performing of the motion compensation comprises:
receiving a block mode and the motion vector and macroblock information for a macroblock of the bitstream;
transforming the block mode of the macroblock into one of 16×16 and 8×8 block modes; and
mapping motion vectors in the macroblock to motion vectors in one of 16×16 and 8×8 blocks.

3. The transcoding method of claim 1, wherein the first coding method complies with an H.264 standard and the second coding method complies with an MPEG-4 standard.

4. A transcoding method, comprising:
receiving block mode and motion vector information for a macroblock of video encoded using a predetermined coding method;
transforming a block mode of the macroblock into one of 16×16 and 8×8 block modes; and
mapping a motion vector in the macroblock to a motion vector in one of 16×16 and 8×8 blocks.

5. The transcoding method of claim 4, further comprising:
performing motion estimation on pixels neighboring a pixel with coordinates of the mapped motion vector to obtain motion vector coordinates, making half pixels around pixels with the obtained motion vector coordinates, and performing motion estimation on the half pixels to determine the mapped motion vector in the macroblock.

6. The transcoding method of claim 4, wherein the predetermined coding method complies with an H.264 standard.

7. The transcoding method of claim 4, wherein the transforming of the block mode of the macroblock further comprises transforming the block mode of the macroblock into one of intra-16×16, inter-16×16, and inter-8×8 modes based on the block mode of the macroblock.

8. The transcoding method of claim 7, wherein when the block mode of the macroblock is one of intra-16×16 and intra-4×4 modes, the block mode is transformed into the intra-16×16 mode.

9. The transcoding method of claim 7, wherein when the block mode of the macroblock is one of inter-16×16 and skip modes, the block mode is transformed into the inter-16×16 mode.

10. The transcoding method of claim 7, wherein when the block mode of the macroblock comprises three information blocks, the block mode is transformed into the intra-16×16 mode.

11. The transcoding method of claim 7, wherein when the block mode of the macroblock comprises one or two information blocks or is one of inter-16×8, inter-8×1 6, and inter-P8 modes, the block mode is transformed into the inter-8×8 mode.

12. The transcoding method of claim 4, wherein an average of motion vectors in blocks in the macroblock corresponding to the 8×8 block, in which the motion vector is to be determined, is mapped as the motion vector for the 8×8 block.

13. The transcoding method of claim 4, wherein when a block in the macroblock corresponding to the 8×8 block, in which the motion vector is to be determined, is an intra block, motion vectors in blocks adjacent to the intra block are averaged to map the average as the motion vector for the 8×8 block.

14. The transcoding method of claim 4, wherein the mapping of the motion vector in the macroblock to the motion vector in one of 16×16 and 8×8 blocks includes mapping with a ratio of 1:1, 2:1, or 4:1.

15. The transcoding method of claim 4, wherein the block mode is one of intra-16×16, inter-16×16, and inter-8×8 modes.

16. A transcoding apparatus, comprising:
a decoder to decode a bitstream, encoded using a first coding method, to output data in a pixel domain along with motion vector and macroblock information for each of macroblock of the bitstream; and
an encoder to receive the data in the pixel domain and perform motion compensation using the motion vector and macroblock information to encode the data in the pixel domain using a second coding method.

17. The transcoding apparatus of claim 16, wherein the encoder comprises a motion compensator to receive information on a block mode and motion vector in a macroblock of the bitstream, to transform the block mode into one of 16×16 and 8×8 modes, and to map the motion vector to a motion vector in the one of 16×16 and 8×8 blocks.

18. The transcoding apparatus of claim 17, wherein the motion compensator performs motion estimation on pixels neighboring a pixel with coordinates of the mapped motion vector to obtain motion vector coordinates, makes half pixels around pixels with the obtained motion vector coordinates, and performs motion estimation on the half pixels to determine the mapped motion vector in the macroblock.

19. The transcoding apparatus of claim 16, wherein the first coding method complies with an H.264 standard and the second coding method complies with an MPEG-4 standard.

20. A transcoding apparatus, comprising:
a decoder to decode a bitstream, encoded using a first coding method, to output data in a pixel domain; and
an encoder to receive the data in the pixel domain and to encode the data in the pixel domain using a second coding method with motion compensation based on motion compensation information obtained during the decoding of the bitstream encoded using the first coding method.

21. The transcoding apparatus of claim 20, wherein the first coding method complies with an H.264 standard.

22. The transcoding apparatus of claim 21, wherein the second coding method complies with an MPEG-4 standard.

23. The transcoding apparatus of claim 20, wherein the motion compensation information obtained during the decoding of the bitstream encoded using the first coding method is motion vector and macroblock information.

24. The transcoding apparatus of claim 20, wherein the encoder maps a motion vector in a macroblock of the bitstream to a motion vector in one of 16×1 6 and 8×8 blocks.

25. An encoding apparatus, comprising:
an encoder to encode data in a pixel domain using a first coding method with motion compensation based on motion compensation information obtained during a previous decoding of encoded data, corresponding to the data encoded by the encoder, encoded with a second coding method.

26. The encoding apparatus of claim 25, wherein the second coding method complies with an H.264 standard.

27. The transcoding apparatus of claim 26, wherein the first coding method complies with an MPEG-4 standard.

28. A medium comprising computer readable code controlling a computing device to perform the method of claim 1.

29. A medium comprising computer readable code controlling a computing device to perform the method of claim 4.

30. A medium comprising computer readable code controlling the transcoding apparatus of claim 14 to control the decoder to output the data in the pixel domain along with the motion vector and macroblock information and to encode the received pixel domain data, perform the motion compensation, and encode the data in the pixel domain using the second coding method.

31. A medium comprising computer readable code controlling the transcoding apparatus of claim 20 to control the decoder to output the data in the pixel domain and to encode the data in the pixel domain.

32. A medium comprising computer readable code controlling the encoder apparatus of claim 25 to control the encoding of the data in the pixel domain.

33. The medium of claim 32 wherein the encoder apparatus is a computer.
